(19) United States
(12) Patent Application Publication
(10) Pub. No.: US 2005/0031342 A1
(43) Pub. Date: Feb. 10, 2005

(54) Method of pilot-tone signal transmission on an optical fiber and a system thereof

(76) Inventors: Yongjun Wu, Shenzhen (CN); Xingyue Sha, Shenzhen (CN)

Correspondence Address: HARNESS, DICKEY & PIERCE, P.L.C., P.O. BOX 828, BLOOMFIELD HILLS, MI, 48303, US

(21) Appl. No.: 10/911,780

(22) Filed: Aug. 4, 2004

(30) Foreign Application Priority Data
Aug. 6, 2003 (CN) 03143967.5

(51) Int. Cl. H04B 10/08

(52) U.S. Cl. 398/32

(57) ABSTRACT

The invention discloses a pilot-tone signal transmission method and a system thereof. The method includes that at transmitting end, converting physical characteristics of an original pilot-tone signal, and then transmitting the converted pilot-tone signal on an optical fiber; at receiving end, anti-converting physical characteristics of the pilot-tone signal extracted from the optical fiber to recover to the said original pilot-tone signal. The system includes a source device, a target device, an electro-optical converter, optical fibers, an optic-electronic converter, a signal-extracting device, a signal-converting device and a signal-anti-converting device. With the above technical scheme, the invention overcomes carrier/noise ratio limitation, provides better SN ratio performance, and can effectively recover the pilot-tone signal to its original form even the SN ratio condition is worse.

### CROSS-REFERENCE TO RELATED APPLICATIONS

This application claims the benefit of Chinese Patent Application No. 03143967.5 filed on Aug. 6, 2003. The disclosure of the above application is incorporated herein by reference.

### FIELD OF THE INVENTION

The invention generally relates to transmission technology on an optical network, specifically to a method of a pilot-tone signal transmission on an optical fiber and a system thereof.

### BACKGROUND OF THE INVENTION

Since 90's of last century, accompanying with the rapid development of the WDM (Wavelength Division Multiplexing) technology, the monitoring technique of WDM networks has been developed. There are three ways to transmit monitor message of a WDM network: a monitoring channel with a specific wavelength, a pilot-tone and a segment overhead. With the pilot-tone technique, small amplitude of an analog or digital signal is added to main signal such as traffic signal at the transmitting end of the WDM network. Message of the pilot-tone service mainly includes wavelength identifiers, state information, optical channel connection and optical channel quality etc., through which every channel state is monitored in real time; this is significant to guarantee the reliability and security of a network operation.

An advantage of the pilot-tone technique is to save optical channels, since the same optical channel bears both main signal and pilot-tone signal at the same time. Nevertheless, a disadvantage of the pilot-tone technique is the spectrum overlap between the main signal and the pilot-tone signal; the pilot-tone signal is a noise to the main signal, and adding the pilot-tone signal will decrease the SN (Signal-to-Noise) ratio of the main signal; the main signal is a noise to the pilot-tone signal too, which cannot be suppressed. It is still a challenge that how to increase the SN ratio of the pilot-tone signal and how to decrease the impact on sensitivity of the main signal.

As shown in FIG. 1, at present, a digital pilot-tone signal mainly uses the coding technique. At the transmitting end, two code sequences represent logic 1 and logic 0 of the pilot-tone signal, respectively, which are added on the main signal for transmission; at the receiving end, the signal coming from the optical fiber is separated into the main signal and the pilot-tone signal, and the later is compared with an effective code sequence to recover to the original pilot-tone signal.

Disadvantages of the digital coding scheme of the pilot-tone are as follow: the amplitude of a pilot-tone signal cannot be too small, randomness of the pseudo random sequence is not good enough, anti-jamming ability is worse etc.; when a pilot-tone signal can be effectively received, it will more impact on the main signal.

### SUMMARY OF THE INVENTION

Objective of the invention is to provide a method for the pilot-tone signal transmission and a system thereof, which decreases impact on the main signal and improves SN ratio of the pilot-tone signal.

The invention is implemented in the following technique scheme:

A pilot-tone signal transmission method, comprising, at transmitting end, converting physical characteristics of an original pilot-tone signal, and then transmitting the converted pilot-tone signal on an optical fiber;
at receiving end, anti-converting physical characteristics of the pilot-tone signal extracted from the optical fiber to recover to the said original pilot-tone signal.

A pilot-tone signal transmission system comprises, a source device, providing an original pilot-tone signal;
a target device, receiving a recovered pilot-tone signal;
an electro-optical converter, converting the received pilot-tone signal and main signal from exterior of the pilot-tone signal transmission system into an optical signal, and outputting said converted signal to an optical fiber;
an optical fiber, being used for optical signal transmission;
an optical-electronic converter, converting an optical signal to an electrical signal, and a signal-extracting device, being used to extract the pilot-tone signal from an electrical signal outputted from the optical-electronic converter;
the system further including:
a signal-converting device, converting physical characteristics of the original pilot-tone signal coming from the source device and outputting the converted pilot-tone signal to the electro-optical converter;
a signal-anti-converting device, anti-converting physical characteristics of the pilot-tone signal outputted from the signal-extracting device to recover the converted pilot-tone signal to its original form, and outputting to the target device.

The invention deploys modulation technique in the electrical signal propagation area and/or spread spectrum technique in the wireless area to a pilot-tone signal transmission on an optical fiber. Comparing with the present pilot-tone signal transmission technique under the same receiving sensitivity degradation, the invention provides better SN ratio performance, overcomes carrier/noise ratio limitation, and can effectively recover the pilot-tone signal to its original form even the SN ratio condition is worse.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a pilot-tone technique diagram based on digital coding in the present technology.

FIG. 2 shows a pilot-tone technique diagram based on digital modulation.

FIG. 3 shows a pilot-tone technique diagram based on spread spectrum.

FIG. 4 shows a pilot-tone technique diagram based on combination of digital modulation and spread spectrum.

FIG. 5 shows a pilot-tone technique diagram based on another combination of digital modulation and spread spectrum.

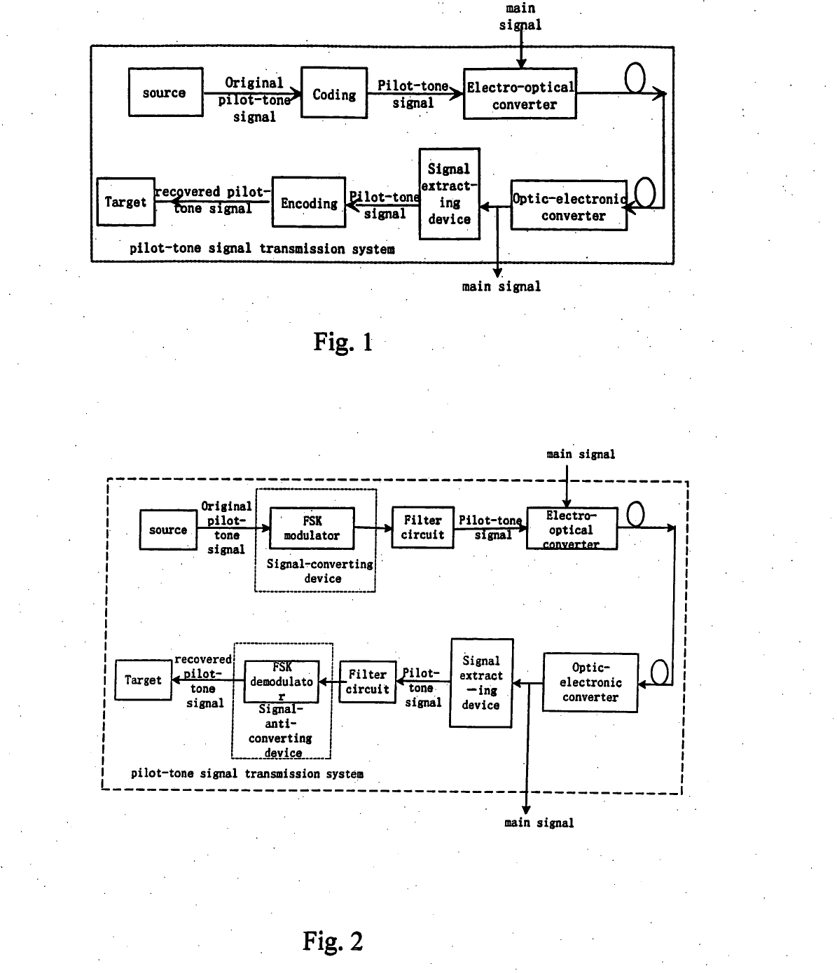

### DETAILED DESCRIPTION OF THE PREFERRED EMBODIMENTS

The following description of the preferred embodiment(s) is merely exemplary in nature and is in no way intended to limit the invention, its application, or uses.

The invention will be described in more detail with reference to the drawings.

For electrical wave propagation, any carrier wave has three characteristics: an amplitude (A), a frequency (f) and a phase (P). Accordingly, there are three basic digital modulation techniques: the Amplitude Shift Keying (ASK), the Frequency Shift Keying (FSK) and the Phase Shift Keying (PSK). The digital modulation converts the base band waveform into a waveform that is suitable for transmission on a channel, and raises signal anti-jamming ability through interchangeable between the bandwidth and SN ratio. The invention takes the digital modulation technique in a pilot-tone signal in order to reduce its interference in the main signal.

As shown in FIG. 2, at the transmitting end, a signal conversion device includes a FSK modulator that modulates the original pilot-tone signal on a suitable carrier (about 10 MHz), and then the modulated signal is used for modulating a laser that converts an electrical signal to an optical signal; at the same time, the laser convert the electrical signal of the main signal to the optical signal. Therefore, the optical signal transmitted on the optical fiber includes both, the main signal and the pilot-tone signal. At the receiving end, an optical detector, such as a photodiode or an avalanche photodiode, detects the inputted optical signal, and converts the optical signal to an electrical signal, which includes main signal and the pilot-tone signal. There is a signal-extracting device that extracts and amplifies the pilot-tone signal from the electrical signal, and then a FSK demodulator at the anti-conversion device demodulates the amplified pilot-tone signal; after that the pilot-tone signal is recovered to its original form. In the signal conversion device at the transmitting end and the signal anti-conversion device at the receiving end, filter circuits are deployed, respectively, for shaped-filter to raise the signal quality.

The modulation mode of a modulator or a demodulator can be one of the three basic digital modulation modes: ASK, FSK and PSK, or their improved modes or any combination.

In the wireless communication field, the spread spectrum technique spreads a signal to a wider spectrum and then transmits it. It is characterized that the bandwidth of a transmitted signal has tens or even thousands times the said signal bandwidth, and a gain is obtained directly. With this gain, the signal-to-noise ratio on a transmission line can be decreased; in some cases it can be less than 0 dB.

For example, suppose the receiving SN ratio threshold of a main signal A₁=20 dB, the receiving SN ratio threshold of the pilot-tone signal A₂=10 dB, the noise power spectrum density N=1, the main signal bandwidth is 2.5 GHz, the pilot-tone signal bandwidth is spread from 10 KHz to 2.5 GHz, and then the gain obtained from the spread spectrum is 101 g2.5 G/10K=53 dB. Suppose the power spectrum density of the main signal is S₁, the power spectrum density of the pilot-tone signal before spread spectrum is S₂, the power spectrum density of the pilot-tone signal after spread spectrum is S₂, and the mutual interference of S₁ and S₂ can be seen as a white noise, the following equation set exists:

$$\{ \begin{matrix} {S}_{1} / ( {S}_{2}^{′} + N ) > 20 dB \\ {S}_{2} / ( {S}_{1} + N ) > 10 dB \\ {S}_{2} / {S}_{2}^{′} = 53 dB\end{matrix}$$

There are many solutions for this equation set; following is a solution satisfying that the S₁/N and S₂/N are as small as possible:

$$\{ \begin{matrix} {S}_{1} / N = 21 dB \\ {S}_{2} / N = 32 dB \\ {S}_{2}^{′} / N = 32 dB - 53 dB = - 21 dB\end{matrix}$$

At this moment, the main signal SN ratio at the receiving end is:
A₁=S₁/(S_{2′}+N)≈21 dB>20 dB

The pilot-tone signal SN ratio is: A₂=S₂/(S₁+N)≈11 dB>10 dB.

Therefore, with this configuration, SN ratio of the main signal and SN ratio of the pilot-tone signal are satisfied at the receiving end.

The above example shows that the SN ratio of the pilot-tone signal added on the main signal has only −21 dB. This means that the pilot-tone signal is drowned in noise, so the pilot-tone signal has only a very little influence on receiving sensitivity of the main signal. The emitting power of the main signal increases S1-20 dB=1 dB because of adding the pilot-tone signal on the main signal. Therefore, after spread spectrum, adding a pilot-tone signal on the main signal has only a less influence on the main signal. For the same reason, on a transmission line, when the main signal has a definite interference on the pilot-tone signal, the SN ratio of the pilot-tone signal at the receiving end is increased obviously, and this will greatly reduce the error rate of a received signal.

Since the bandwidth of a pilot-tone signal after spread spectrum equals to the bandwidth of the main signal, the ratio of the main signal emission power and the pilot-tone signal emission power equals to the ratio of power spectrum densities of the two signals, i.e. 21 dB-(−21 dB)=42 dB. Suppose the total emission power is 1W, only 10^{-4.2}W is the emission power of the pilot-tone signal, which is only a small part of the total emission power.

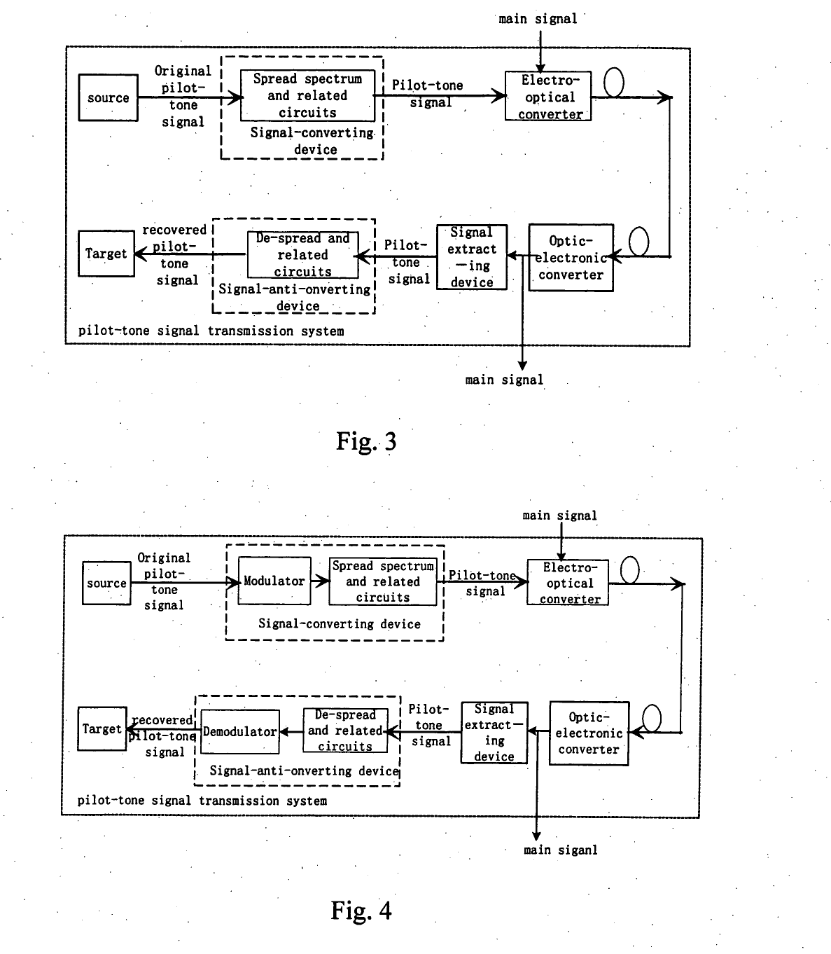

As shown in FIG. 3, at the transmitting end, a signal conversion device at least includes a spread spectrum circuit that spreads the original pilot-tone signal and makes other related processing including shaped-filter, and then the spread signal is converted to an optical signal. Therefore, the optical signal transmitted on the optical fiber includes both, the main signal and the pilot-tone signal. At the receiving end, an optical detector, such as a photodiode or an avalanche photodiode, detects the optical signal in order to convert the optical signal to an electrical signal, which includes the main signal and the pilot-tone signal. A signal-extracting device extracts and amplifies the pilot-tone signal from the electrical signal, and then a de-spread circuit and related circuit at the signal anti-conversion device makes de-spread and other related processing, after that the pilot-tone signal is recovered to its original form. Said related processing includes match filtering etc.

FIG. 4 shows a pilot-tone scheme deploying modulation and spread spectrum techniques; it is the combination of FIGS. 2 and 3. Specifically, it adds a spread spectrum and de-spread processing on the system shown in FIG. 2. At the transmitting end, a signal conversion device at least includes a modulator and a spread spectrum circuit. The modulator modulates the original pilot-tone signal, and then the modulated signal is spread and processed with shaped-filter to obtain a wideband spread spectrum signal that is outputted to the laser which implements conversion from an electrical signal to an optical signal. Therefore, the optical signal transmitted on the optical fiber includes both, the main signal and the pilot-tone signal. At the receiving end, the signal anti-conversion device at least includes a demodulator and a de-spread circuit. The optical signal transmitted on the optical fiber is detected by an optical detector, such as a photodiode or an avalanche photodiode, and converted the optical signal to an electrical signal, which includes the main signal and the pilot-tone signal. A signal-extracting device extracts and amplifies the pilot-tone signal from the electrical signal, and then the extracted pilot-tone signal is de-spread and demodulated by the de-spread circuit and demodulator, respectively; after that the original pilot-tone signal is recovered.

From FIGS. 2 to 4, the electro-optical converter includes a laser and a resistance-capacitance circuit; said pilot-tone signal is added on the laser through the resistance-capacitance circuit; said signal-extracting device is consisted of a resistance-capacitance circuit or an electrical coupler.

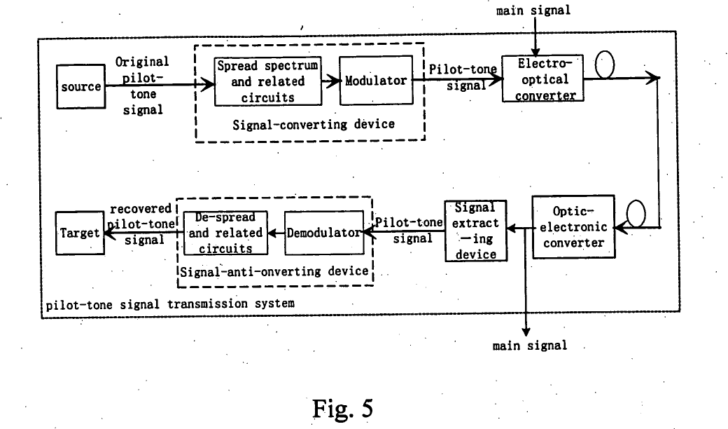

The system shown in FIG. 5 is basically similar with the one shown in FIG. 4 except that the modulator and spread spectrum device at the transmitting end are reversed at their positions, and the demodulator and de-spread device at the receiving end are reversed at their positions too.

A system that combines the modulation and spread spectrum techniques may have more gain, so the pilot-tone signal can be recovered effectively under a low amplitude modulation index, which is the ratio of the amplitude of pilot-tone signal to the amplitude of main signal. With the same amplitude modulation index, the system can have lower error code rate.

Except the modulation and spread spectrum techniques mentioned above, a error code detection and correction techniques also can be added to the system, such as the forward error correction, interleaving and scrambling code etc., to further improve a system performance.

The description of the invention is merely exemplary in nature and, thus, variations that do not depart from the gist of the invention are intended to be within the scope of the invention. Such variations are not to be regarded as a departure from the spirit and scope of the invention.

1. An pilot-tone signal transmission method, comprising,
at transmitting end, converting physical characteristics of an original pilot-tone signal, and then transmitting the converted pilot-tone signal on an optical fiber;
at receiving end, anti-converting physical characteristics of the pilot-tone signal extracted from the optical fiber to recover to the said original pilot-tone signal.

2. The pilot-tone signal transmission method according to claim 1, wherein the step of converting physical characteristics of an original pilot-tone signal comprises, modulating the original pilot-tone signal;
the step of anti-converting physical characteristics of the pilot-tone signal extracted from the optical fiber comprises, demodulating the said pilot-tone signal extracted from the optical fiber.

3. The pilot-tone signal transmission method according to claim 1, wherein the step of converting physical characteristics of an original pilot-tone signal comprises, making spread spectrum processing for the original pilot-tone signal;
the step of anti-converting physical characteristics of the pilot-tone signal extracted from the optical fiber comprises, making de-spread processing for the said pilot-tone signal extracted from the optical fiber.

4. The pilot-tone signal transmission method according to claim 1, wherein the step of converting physical characteristics of an original pilot-tone signal comprises, first modulating original pilot-tone signal, and then making spread spectrum processing for the modulated pilot-tone signal,
the step of anti-converting physical characteristics of the pilot-tone signal extracted from the optical fiber comprises, first making de-spread processing for the said pilot-tone signal extracted from the optical fiber, and then demodulating the de-spread pilot-tone signal.

5. The pilot-tone signal transmission method according to claim 1, wherein the step of converting physical characteristics of an original pilot-tone signal comprises, making spread spectrum processing for the original pilot-tone signal first and then modulating the spread pilot-tone signal,
the step of anti-converting physical characteristics of the pilot-tone signal extracted from the optical fiber comprises, demodulating the said pilot-tone extracted from the optical fiber first, and then making de-spread processing for the demodulated pilot-tone signal.

6. The pilot-tone signal transmission method according to claim 2 wherein the step of modulating comprises, frequency modulating, amplitude modulating, phase modulating or combination of them.

7. A pilot-tone signal transmission system comprises,
a source device, providing an original pilot-tone signal;
a target device, receiving a recovered pilot-tone signal;
an electro-optical converter, converting the received pilot-tone signal and main signal from exterior of the pilot-tone signal transmission system into an optical signal, and outputting said converted signal to an optical fiber;
an optical fiber, being used for optical signal transmission;
an optical-electronic converter, converting an optical signal to an electrical signal, and
a signal-extracting device, being used to extract the pilot-tone signal from an electrical signal outputted from the optical-electronic converter;
the system further including:
a signal-converting device, converting physical characteristics of the original pilot-tone signal coming from the source device and outputting the converted pilot-tone signal to the electro-optical converter;
a signal-anti-converting device, anti-converting physical characteristics of the pilot-tone signal outputted from the signal-extracting device to recover the converted pilot-tone signal to its original form, and outputting to the target device.

8. The pilot-tone transmission system according to claim 7, the signal-converting device is a modulation device that modulates an incoming pilot-tone signal; the signal-anti-converting device is a demodulation device that demodulates an incoming pilot-tone signal.

9. The pilot-tone transmission system according to claim 7, the signal-converting device is a spread spectrum device that spreads an incoming pilot-tone signal, the signal-anti-converting device is a de-spread device that de-spreads an incoming pilot-tone signal.

10. The pilot-tone transmission system according to claim 7, the signal-converting device includes a modulation device and a spread spectrum device, wherein output of the source device is connected to input of the modulation device, and output of the modulation device is connected to input of the spread spectrum device, and output of said spread spectrum device is connected to the electro-optical converter;
said signal-anti-converting device includes a demodulator device and a de-spread device, wherein output of said signal-extracting device is connected to input of the de-spread device, and output of the de-spread device is connected to input of the demodulation device, and output of the demodulation device is connected to the target device.

11. The pilot-tone transmission system according to claim 7, the signal-converting device includes a modulation device and a spread spectrum device, wherein output of the source device is connected to input of the spread spectrum device, and output of the spread spectrum device is connected to input of the modulation device, and output of the modulation device is connected to the electro-optical converter;
the signal-anti-converting device includes a demodulator device and a de-spread device, wherein output of the signal-extracting device is connected to input of the demodulation device, and output of the demodulation device is connected to input of the de-spread device, and output of the de-spread device is connected to the target device.

12. The pilot-tone transmission system according to claim 8, the modulation device is a frequency modulation device, an amplitude modulation device, a phase modulation device or a combination of them;
the de-modulation device is a frequency modulation device, an amplitude modulation device, a phase modulation device or a combination of them, which corresponds to the modulation device.

13. The pilot-tone transmission system according to claim 7, the electro-optical converter comprises a laser and a resistance-capacitance circuit, adding the pilot-tone signal on the laser through the resistance-capacitance circuit.

14. The pilot-tone transmission system according to claim 7, the signal-extracting device is a resistance-capacitance circuit.

15. The pilot-tone transmission system according to claim 7, the signal-extracting device is an electrical coupler.
